(19) United States
(12) Patent Application Publication
(10) Pub. No.: US 2016/0224854 A1
(43) Pub. Date: Aug. 4, 2016

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Naoki Ito, Kashiwa-shi (JP)

(21) Appl. No.: 15/009,150

(22) Filed: Jan. 28, 2016

(30) Foreign Application Priority Data
Jan. 30, 2015 (JP) 2015-017098

(51) Int. Cl. G06K 9/20; G06T 7/40; G06T 5/00; G06T 7/00; G06K 9/46

(52) U.S. Cl. CPC G06K 9/2054; G06T 7/004; G06K 9/4652; G06T 5/006; G06T 5/002; G06T 7/408; G06T 2207/30244; G06T 2210/22; G06T 2207/10024

(57) ABSTRACT

An information processing apparatus includes an acquisition unit that acquires posture information of an imaging unit, an extraction unit that extracts characteristic amount information of an image imaged by the imaging unit, an identification unit that identifies a subject included in the image imaged by the imaging unit using the posture information acquired by the acquisition unit and the characteristic amount information extracted by the extraction unit, a recognition unit that recognizes a subject area in the image in a recognition mode according to the subject identified by the identification unit, and a correction unit that corrects the image including the subject area by clipping, from the image, the subject area recognized by the recognition unit.

### BACKGROUND

1. Field

Aspects of the present invention generally relate to an information processing apparatus, an information processing method, and a storage medium.

2. Description of the Related Art

In recent years, portable terminals having high information processing functions such as a smartphone and a tablet personal computer (PC) have become widespread. These portable terminals each include a camera and have an imaging function (a camera function). In this type of portable terminal, a document of a paper medium is imaged using the camera function to be stored as image data in a memory of the portable terminal.

For example, Japanese Patent Application Laid-Open No. 2014-36323 discusses a technique for setting an operation mode according to an imaging direction at the time of imaging, when displaying a photographic image. In this technique, image display is performed according to association between direction information indicating the imaging direction and the photographic image obtained by imaging a subject. Further, in this technique, a function of setting an operation mode concerning a display changing operation for a displayed image is provided, so that a change in display is performed in accordance with the changing operation according to the set operation mode.

As described above, Japanese Patent Application Laid-Open. No. 2014-36323 discusses the technique for changing the window for an operator when the operator operates the camera, according to an orientation of the camera. This technique improves operability of an operation window when the operator moves and operates the camera. For example, in this technique, when an orientation of imaging is established, operation display suitable for this orientation is provided, and the operation mode is determined according to the orientation. However, in Japanese Patent Application Laid-Open No. 2014-36323, processing not suitable for the characteristic of an image may be performed, when a mode (for display and processing) is changed only using the orientation (three directions of an upward direction, a downward direction, and a sideward direction) of the camera as illustrated in FIG. 8A.

### SUMMARY

Aspects of the present invention is generally directed to a technique that processes a photographic image more appropriately, according to a posture of a portable terminal when an imaging object is imaged.

According to an aspect of the present invention, an information processing apparatus includes an acquisition unit configured to acquire posture information of an imaging unit, an extraction unit configured to extract characteristic amount information of an image imaged by the imaging unit, an identification unit configured to identify a subject included in the image imaged by the imaging unit using the posture information acquired by the acquisition unit and the characteristic amount information extracted by the extraction unit, a recognition unit configured to recognize a subject area in the image in a recognition mode according to the subject identified by the identification unit, and a correction unit configured to correct the image including the subject area by clipping, from the image the subject area recognized by the recognition unit.

Further features of aspects of the present invention will become apparent from the following description of exemplary embodiments with reference to the attached drawings.

### BRIEF DESCRIPTION OF THE DRAWINGS

FIG. 1 is a diagram illustrating an example of a system configuration.

FIGS. 2A and 2B are diagrams each illustrating an example of an external view of a portable terminal.

FIG. 3 is a diagram illustrating an example of a hardware configuration of the portable terminal.

FIG. 4 is a diagram illustrating an example of a software configuration of the portable terminal.

FIG. 5 is a flowchart illustrating an example of a series of processing steps in a first exemplary embodiment.

FIG. 6 is a diagram illustrating an example of each of a photographic image and a document area.

FIG. 7 is a diagram illustrating an example of a tilt of the portable terminal.

FIGS. 8A and 8B are diagrams each illustrating an example of a rotation angle of the portable terminal.

FIG. 9 is an explanatory diagram of a rotation direction and a rotation angle of the portable terminal.

FIGS. 10A and 10B are explanatory diagrams of a movement direction and a movement amount of the portable terminal.

FIG. 11 is a diagram illustrating an example of a photographic image obtained by imaging a whiteboard.

FIG. 12 is a diagram illustrating an example of a photographic image obtained by imaging a blackboard.

FIG. 13 is a flowchart illustrating an example imaging object recognition processing of the first exemplary embodiment.

FIG. 14 is a flowchart illustrating an example of document area recognition processing.

FIG. 15 is a flowchart illustrating an example of imaging object recognition processing of a second exemplary embodiment.

FIG. 16 is a flowchart illustrating an example of a series of processing steps in a third exemplary embodiment.

FIGS. 17A and 17B are diagrams each illustrating an example of a window displayed in the portable terminal.

FIG. 18 is a flowchart illustrating an example of imaging object recognition processing of a fourth exemplary embodiment.

### DESCRIPTION OF THE EMBODIMENTS

Exemplary embodiments of the present invention will be described below using the drawings.

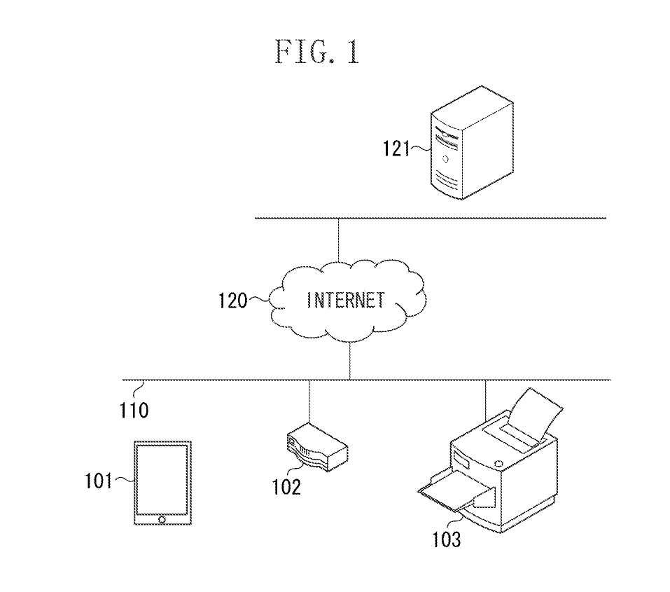

FIG. 1 is a diagram illustrating an example of a system configuration in an information-processing system of an exemplary embodiment. A printer 103 and a wireless router 102 are connected to a local area network (LAN) 110. Further, the LAN 110 is connected to the Internet 120, to be also connected to a server device (hereinafter referred to as “server”) 121 that provides a service via the Internet 120. A portable terminal device (hereinafter referred to as “portable terminal”) 101, the printer 103, and the server 121 are communicably interconnected via the wireless router 102 and the LAN 110, to transmit and receive photographic image data (hereinafter referred to as “photographic image”) and various kinds of information to and from each other. In the example of FIG. 1, the wireless router 102 and the printer 103 are connected to the LAN 110, but the connection form is not limited to this example. Any form may be adopted if the wireless router 102 and the printer 103 are connectable to the server 121. The portable terminal 101 is an example of an information processing apparatus.

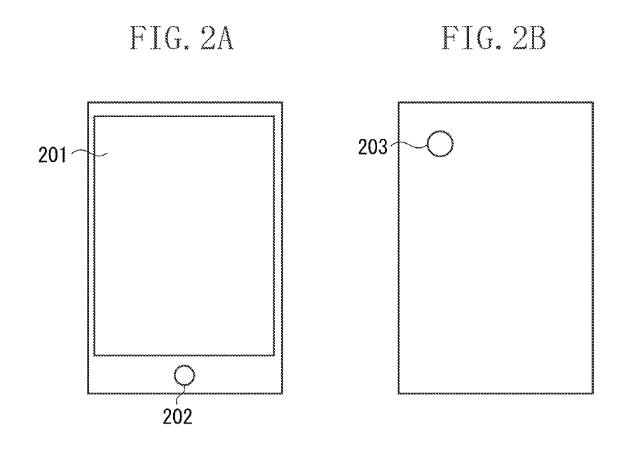

FIGS. 2A and 2B are diagrams each illustrating an example of an external view of the portable terminal 101 used in the present exemplary embodiment. The portable terminal 101 may be of any of various types. FIG. 2A is a diagram illustrating an example of an external view of a front side of the portable terminal 101. The front side has a touch panel display 201 and an operation button 202. FIG. 2B is a diagram illustrating an example of an external view of a back side of the portable terminal 101. A camera 203 is disposed on the back side. The portable terminal 101 in the present exemplary embodiment may be of any type if the portable terminal 101 has a camera function. In other words, the portable terminal 101 in the present exemplary embodiment may be a smartphone or portable telephone having a camera function, or may be a digital camera having a communication function. Further, an autofocus system is provided in the camera 203, thereby automatically detecting an in-focus state based on a contrast ratio, infrared-ray transmitting/receiving timing, and the like. The camera 203 can thereby measure a focal distance and a subject distance. The autofocus system used in the present exemplary embodiment is merely an example of a method for measuring a focal distance and a subject distance, and other methods may be used if a focal distance and a subject distance can be measured.

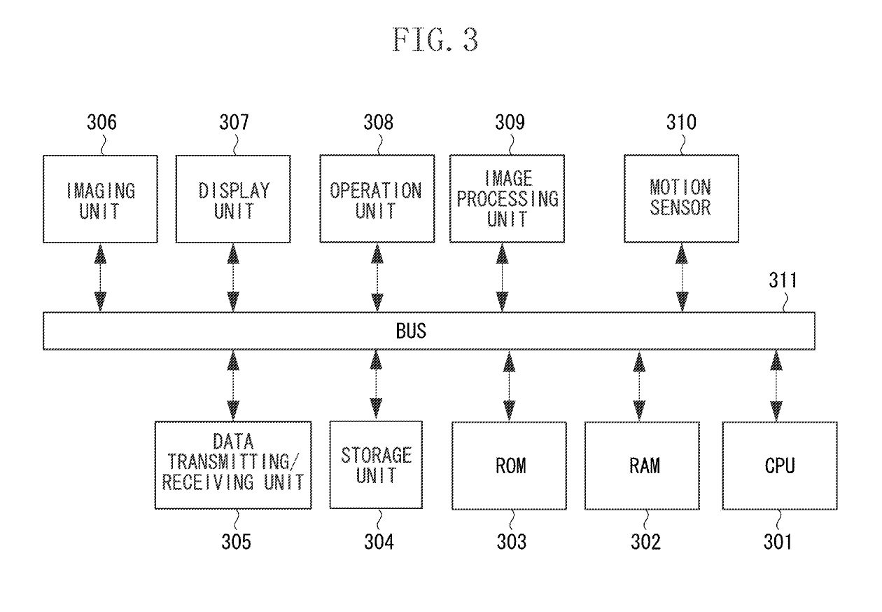

FIG. 3 is a diagram illustrating an example of a hardware configuration of the portable terminal 101. A central processing unit (CPU) 301 controls operations of the entire portable terminal 101, by exchanging data with each part via a data bus 311. To be more specific, the CPU 301 implements processing (information processing) according to a software configuration and a flowchart to be described below of the portable terminal 101, by loading a program stored in a storage unit 304, a read only memory (ROM) 303, a random access memory (RAM) 302, or the like, and executing the loaded program.

The storage unit 304 is, for example, a flash memory, and stores photographic images and various programs to be executed by the CPU 301. A data transmitting/receiving unit 305 has a wireless LAN controller, and implements transmission and reception of data to and from the printer 103 and the server 121, via the wireless router 102. An imaging unit 306 corresponds to the camera 203 described above, and images a document serving as a subject, and transmits a photographic image obtained thereby to each unit. As will be described below in detail for the document, here, imaging objects, which include not only a paper medium but also a board medium such as a blackboard and a whiteboard, are each referred to as a “document”.

A display unit 307 corresponds to the touch panel display 201, and displays a live view when imaging a document using the camera function, or displays various kinds of information such as a document-area recognition result to be described below. An operation unit 308 corresponds to a touch panel and the operation button 202 of the touch panel display 201 described above. The operation unit 308 transmits operation information to each unit, by receiving an operation from a user. A motion sensor (a movement detection unit) 310 includes a three-axis acceleration sensor, an electromagnetic compass, and a three-axis angular velocity sensor, and therefore can detect a posture and a movement of the portable terminal 101.

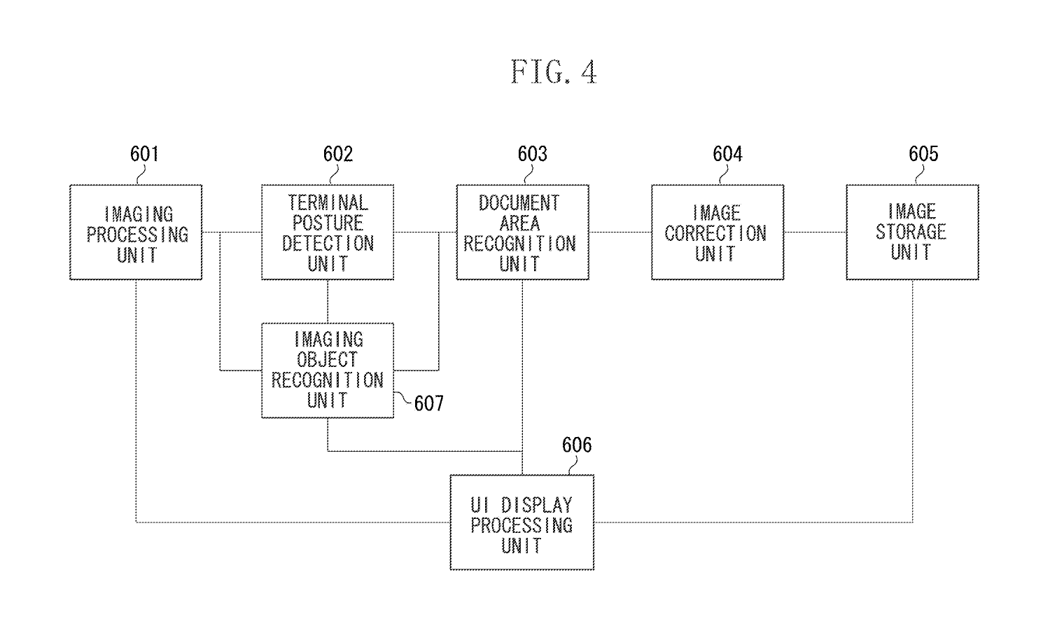

FIG. 4 is a diagram illustrating an example of a software configuration of the portable terminal 101. An imaging processing unit 601 displays a photographic image acquired by the camera 203 in real time, on the touch panel display 201, as a preview image. Further, the imaging processing unit 601 regularly updates this preview image. Furthermore, the imaging processing unit 601 changes the preview image according to a movement of the portable terminal 101 made by the user. This allows live-view imaging. When the imaging is completed, the imaging processing unit 601 transfers to the RAM 302 the photographic image stored in the imaging unit 306. The imaging processing unit 601 may transfer the photographic image to the RAM 302, after storing the photographic image in an external storage device.

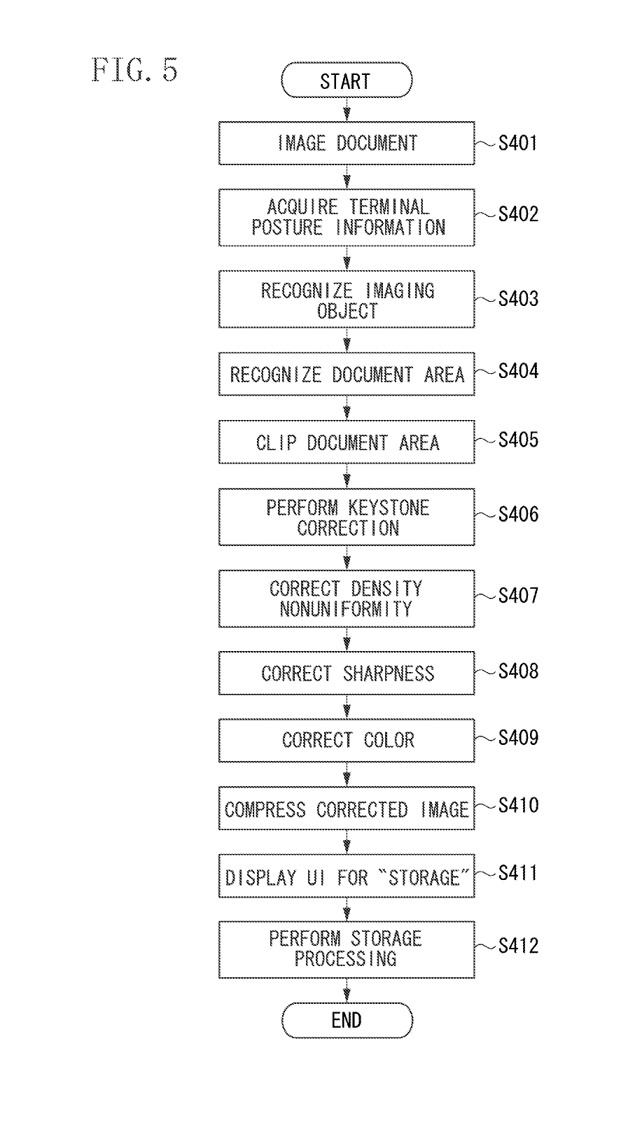

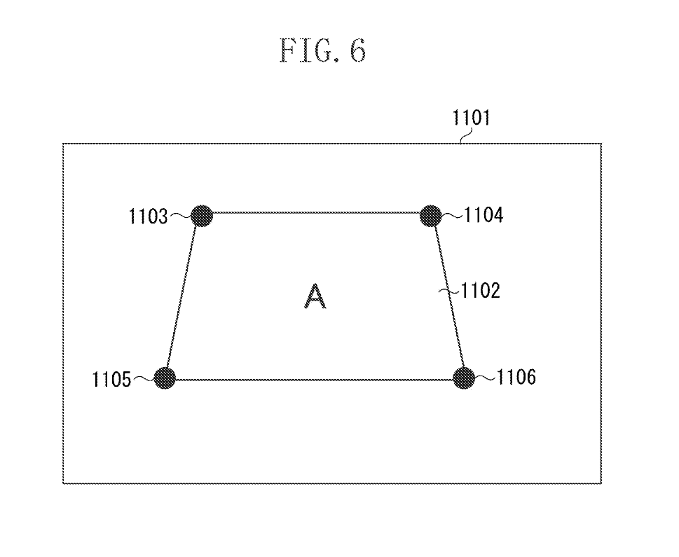

A terminal posture detection unit 602 analyses sensor information acquired by the motion sensor 310, thereby detecting the posture of the portable terminal 101. This will be described below in detail by using figures including FIG. 5. A document area recognition unit 603 detects a document area (a subject area) in the photographic image. As will be described below in detail using FIG. 6, the document area is assumed to be a rectangular area. The document area recognition unit 603 detects an outermost rectangular area in the photographic image, and identifies the detected outermost rectangular area as a document area. To be more specific, first, the document area recognition unit 603 reduces the photographic image to a resolution sufficient for detection of the document area in order to remove an influence of noise. The resolution desirable for the detection of the document area is assumed to be determined beforehand. The document area recognition unit 603 detects a document area using this reduced photographic image.

The document area recognition unit 603 performs edge detection in order to detect an edge (a boundary) between the document and a support where the document is placed, i.e., an edge between the subject area and a background area. The document area recognition unit 603 uses, for example, a scheme such as Canny edge detection for the edge detection. As to a threshold for the edge detection, a fixed threshold may be used, or the threshold may be automatically calculated by the document area recognition unit 603 based on luminance of the image.

An image correction unit 604 performs processing such as density nonuniformity and/or sharpness correction and color correction for the photographic image. An image storage unit 605 transfers the photographic image to the RAM 302, while performing compression and formatting. The image storage unit 605 may transfer the photographic image to the RAM 302, after storing the photographic image in an external storage device. A user interface (UI) display processing unit 606 displays information related to the imaging, the document-area recognition result, and an imaging-object (subject) recognition result in the photographic image to be described below, and the like, on the touch panel display 201. An imaging object recognition unit 607 recognizes an imaging object in the photographic image. In the present exemplary embodiment, the imaging object recognition unit 607 is descried using an example of recognizing each of a whiteboard, a blackboard, and paper as the imaging object, but the imaging object is not limited to this example.

FIG. 5 is a flowchart illustrating an example of processing when the portable terminal 101 extracts a document area in a photographic image and performs image processing on the extracted document area, in a first exemplary embodiment. For example, an area of paper, which is included in a photographic image obtained by imaging the paper, will be referred to as a “document area”. The document area will be described below in detail, using figures including FIG. 6. When a whiteboard is an imaging object, the document area is an area of the whiteboard in the photographic image.

In step S401, the imaging processing unit 601 images a document, when an instruction for imaging is input via the operation unit 308 from a user. The document described here is the above-described imaging object such as the whiteboard, the blackboard, and the paper. In step S402, the terminal posture detection unit 602 acquires posture information of the portable terminal 101 based on sensor information of the motion sensor 310. The sensor information of the motion sensor 310 includes information about an angle and an orientation of the portable terminal 101. The processing in step S402 will be described below in detail. The processing in step S402 is an example of acquisition processing of acquiring the posture information of the portable terminal 101. In step S403, the imaging object recognition unit 607 performs recognition processing of recognizing the imaging object in the photographic image, i.e., imaging object recognition processing. The imaging object recognition processing is, for example, processing of recognizing whether the imaging object is a whiteboard, a blackboard, paper, an object onto which a presentation is projected, or the like. The processing in step S403 will be described below in detail. The processing in step S403 is an example of identification processing of identifying an imaging object in a photographic image.

In step S404, the document area recognition unit 603 performs document area recognition processing. The photographic image includes a background area besides the imaging object. Therefore, the document area recognition unit 603 recognizes the document area, by recognizing an edge (a boundary) between the document area of the imaging object and the background area. Further, the document area recognition unit 603 recognizes the document area by changing a processing mode (a recognition mode) in the document area recognition processing, according to the imaging object recognized in step S403. The processing in step S404 will be described below in detail. The processing in step S404 is an example of recognition processing of recognizing a document area in a photographic image. In step S405, the document area recognition unit 603 clips an image according to the document area recognized in step S404.

In step S406, the image correction unit 604 performs keystone correction of the clipped image. The keystone correction may be implemented by using conventional projective transformation. A scaling parameter is a projective transformation matrix considering an occurrence of trapezoidal distortion. The image correction unit 604 can calculate a projective transformation matrix from apex information (apexes 1103, 1104, 1105, and 1106) of four points of a document area in a photographic image illustrated in FIG. 6, and coordinate information of four corners of an output image. FIG. 6 illustrates a photographic image 1101 and a document area 1102. When priority is given to a processing speed, the image correction unit 604 may calculate an affine transformation matrix or a simple scaling factor as the scaling parameter. The image correction unit 604 can calculate the scaling parameter based on an output image size and the size of a document area in a photographic image. Here, the scaling parameter to be calculated is a parameter for scaling the document area in the photographic image to the output image size.

The user can specify an output image size via a window displayed in the operation unit 308. Output image sizes that can be specified include, for example, A4, A5, B4, and letter-size, and can be set beforehand in the ROM 303. For example, in a case where the output image size is a paper size of A4, the output image size is A4, and the scaling parameter is a parameter for scaling an image of a document area to A4 serving as an output image size. Further, for example, in a case where the output image size is half the paper size of A4, the output image size is A5, and the scaling parameter is a parameter for scaling an image of a document area to A5 serving as an output image size. For the output image size, a paper type series may be changeable to use any one of A-series paper, B-series paper, and inch-series paper, based on an aspect ratio of the document area.

In step S407, the image correction unit 604 corrects density nonuniformity of the photographic image, thereby correcting color irregularity due to a light source and shading at the time of imaging the document. First, the image correction unit 604 performs filter processing to remove noise at the time of the imaging, and then performs tone correction that allows reproduction of white of the paper by removing color appearing on a background. In step S408, the image correction unit 604 sharpens and smooths (performs sharpness correction and smoothness correction on) the image. This can be implemented by performing conventional filter processing or the like. In step S409, the image correction unit 604 performs conversion of the photographic image (color correction) from a color space specific to the camera to a common RGB color space. The conversion of the color space used here is assumed to be conversion from the camera color space of the portable terminal 101 to the colorimetric common RGB color space such as sRGB, which is performed by a 3×3 matrix operation defined beforehand. The processing in each of step S406 to S409 corresponds to an example of image correction processing.

In step S410, the image storage unit 605 performs compression and formatting of the photographic image after the correction. To be more specific, the image storage unit 605 compresses the photographic image after the correction to, for example, a Joint Photographic Experts Group (JPEG) format. The image storage unit 605 then converts JPEG data resulting from this conversion, into a file format (e.g., a Portable Document Format (PDF) or an Extensible Markup Language paper specification (XML paper specification, or XPS) format). In step S411, the UI display processing unit 606 displays a UI for receiving an instruction for performing storage of the file generated in step S410. For example, the UI display processing unit 606 displays a UI for prompting the user to determine whether to store the file. In step S412, the image storage unit 605 performs storage processing of the file to a set area. This area for storage may be an area designated beforehand by an application, or may be an area for storing images held by an operating system (OS) of the portable terminal 101.

This ends the description of an outline of a series of processing steps to be performed by the portable terminal 101 in the present exemplary embodiment. Details of the processing in each of step S402 to step S404 will be described below.

### <S402: Detailed Description of Acquisition Processing of Acquiring Posture Information of Portable Terminal 101>

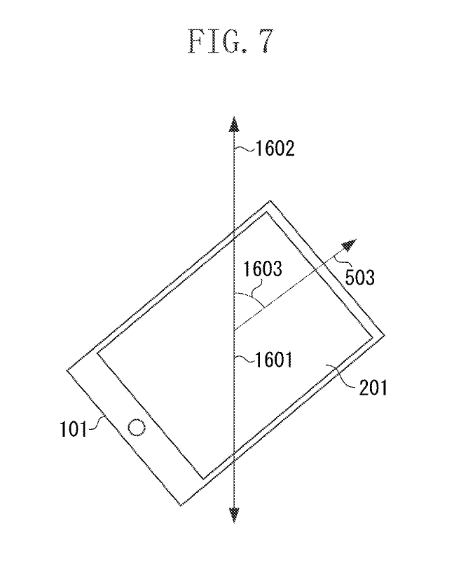

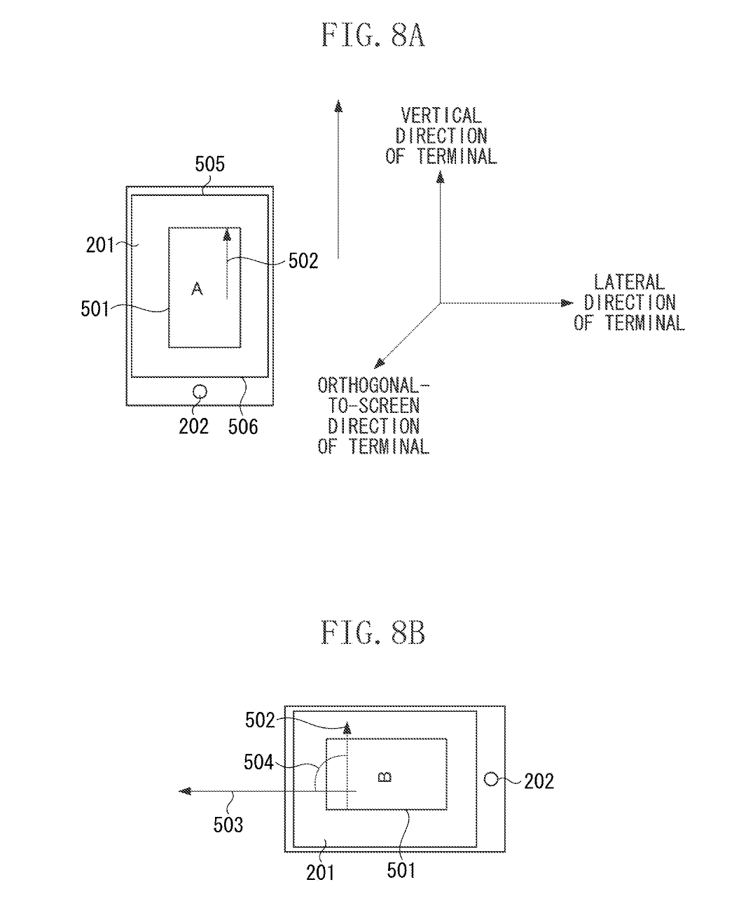

Details of step S402 will be described using FIG. 7 as well as FIGS. 8A and 8B. FIG. 7 is a diagram illustrating an example of a tilt of the portable terminal 101. FIGS. 8A and 8B are diagrams each illustrating an example of a rotation angle of the portable terminal 101. In step S402, the terminal posture detection unit 602 acquires angle information about a tilt 1603 of the portable terminal 101 illustrated in FIG. 7, based on acceleration information acquired from the motion sensor 310. The angle information is an example of the above-described posture information of the portable terminal 101. The angle information is a value calculated from a rotation angle 504 of a window 501 displayed on the touch panel display 201 of the portable terminal 101 illustrated in FIGS. 8A and 8B, and the tilt 1603 of the portable terminal 101 illustrated in FIG. 7. The tilt 1603 of the portable terminal 101 represents a rotation angle when the portable terminal 101 is rotated mainly about an axis of an orthogonal-to-screen direction of the touch panel display 201.

Here, an upward direction of the portable terminal 101 will be described. Top, bottom, right, and left of the portable terminal 101 correspond to top, bottom, right, and left defined in the motion sensor 310, respectively. The motion sensor 310 has three axes of a vertical direction, a lateral direction, and an orthogonal-to-screen direction of the portable terminal 101, and can detect acceleration for each axis (direction). In the first exemplary embodiment, a vector, which is directed from a lower side 506 to an upper side 505 in FIG. 8A in a state where the user maintains the portable terminal 101 in a portrait position, is assume to be the upward direction of the portable terminal 101.

The rotation angle 504 of the window 501 will be described using FIG. 8B. The rotation angle 504 of the window 501 is defined as a value indicating an angle formed when an upward direction 502 of the window 501 rotates clockwise from an upward direction 503 of the portable terminal 101. In FIG. 8B, the upward direction 502 of the window 501 rotates 90 degrees clockwise with reference to the upward direction 503 of the portable terminal 101, and therefore, the rotation angle 504 of the window 501 is 90 degrees. On the other hand, in FIG. 8A, the upward direction 502 of the window 501 matches with the upward direction 503 of the portable terminal 101, and therefore, the rotation angle 504 of the window 501 is 0 degree. The posture information of the portable terminal 101 is thus acquired.

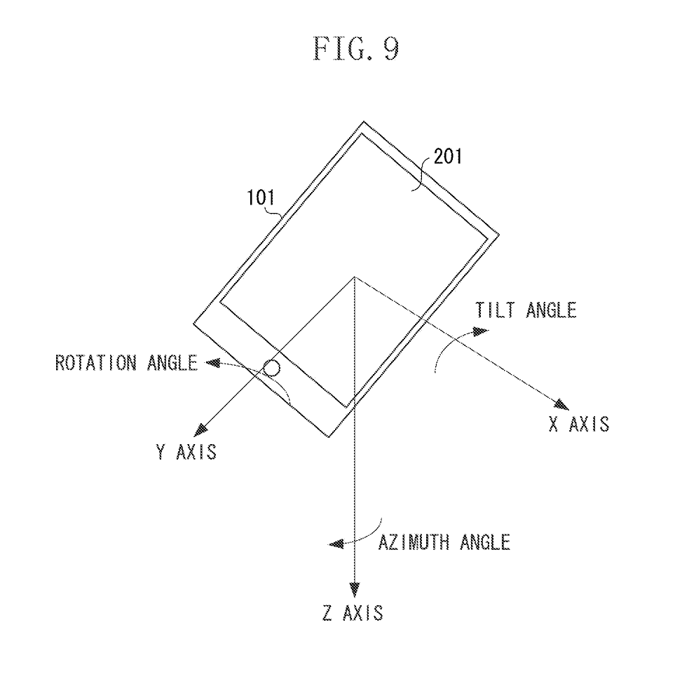

Now, a definition of the tilt 1603 of the portable terminal 101 illustrated in FIG. 7 will be described. In the first exemplary embodiment, the user operates the touch panel display 201 of the portable terminal 101, so that the touch panel display 201 displays the window 501 as illustrated in FIG. 8A. A vector 1601 is formed by projecting a gravity acceleration vector acquired by the motion sensor 310 onto a surface of the touch panel display 201 of the portable terminal 101. A vector 1602 is a vector opposite in direction to the vector 1601. The tilt 1603 of the portable terminal 101 is an angle of clockwise rotation from the vector 1602 to the upward direction 503 of the portable terminal 101. FIG. 9 is an explanatory diagram of a rotation direction and a rotation angle of the portable terminal 101 detected by the terminal posture detection unit 602. In FIG. 9, an orthogonal coordinate system is defined such that a perpendicular direction is assumed to be a Z-axis, a horizontal magnetic North Pole direction is assumed to be a Y-axis, and a direction orthogonal to the Z-axis and the Y-axis is assumed to be an X-axis. The terminal posture detection unit 602 detects an amount of rotation about each of the axes via the motion sensor 310. In each of the three axes, an amount of counterclockwise rotation is positive (+), and an amount of clockwise rotation is negative (−).

The rotation about the X-axis is referred to as a “tilt angle”, and takes a value in a range from “−180 degrees” to “179 degrees”. With reference to the touch panel display 201 of the portable terminal 101, an upward horizontal state is “0 degree”, an upright state is “90 degrees”, a downward horizontal state is “−180 degrees” and “179 degrees”, and an inverted state is “−90 degrees”. The rotation about the Y-axis is referred to as “rotation angle”, and takes a value in a range from “−90 degrees” to “90 degrees”. With reference to the touch panel display 201 of the portable terminal 101, a horizontal state is “0 degree”, a right-shoulder upward state is “90 degrees”, and a left-shoulder upward state is “−90 degrees”. The rotation about the Z-axis is referred to as “azimuth angle”, and takes a value in a range from “0 degree” to “359 degrees”. With reference to a short-side top surface of the portable terminal 101, a top-surface northward state is “0 degree”, a top-surface eastward state is “90 degrees”, a top-surface southward state is “180 degrees”, and a top-surface eastward state is “270 degrees”. As illustrated in FIG. 9, the portable terminal 101 is in a state of being maintained such that the touch panel display 201 of the portable terminal 101 is directed upward and the short-side top surface of the portable terminal 101 is directed northward. This state is a reference state (a state in which the rotation angle, the tilt angle, and the azimuth angle all become “0 degree”) of the rotation angle. The terminal posture detection unit 602 detects an amount of a change from this reference state, as a rotation direction and a rotation angle of the portable terminal 101.

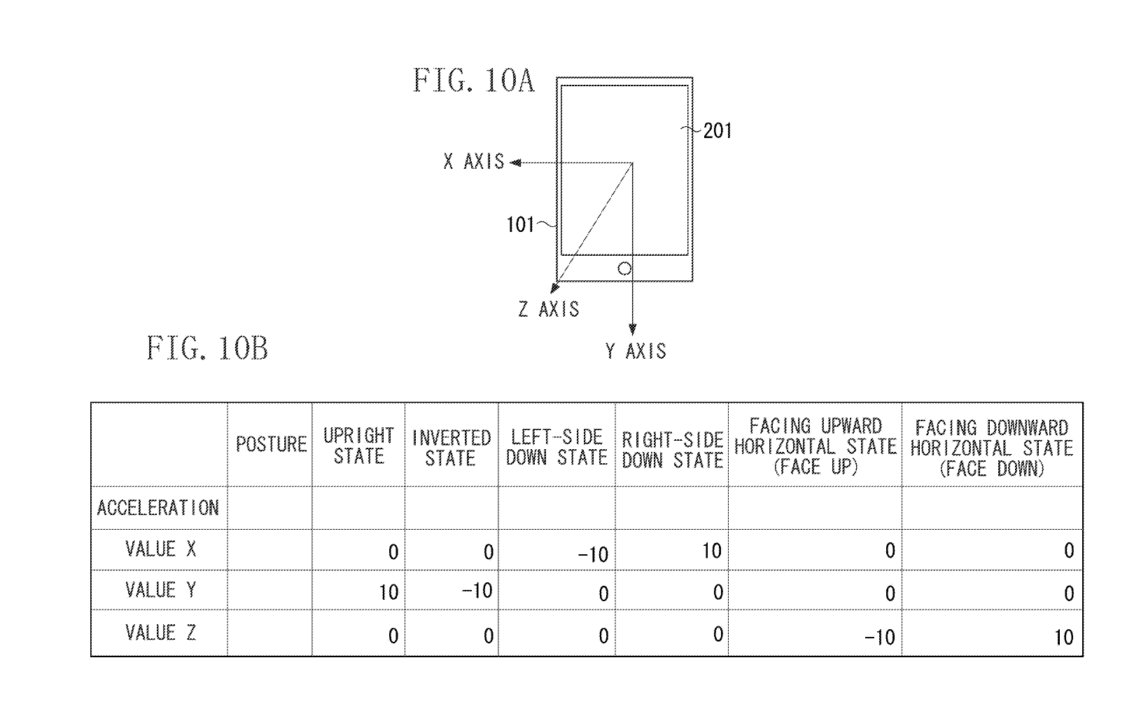

FIGS. 10A and 10B are explanatory diagrams of a movement direction and a movement amount of the portable terminal 101 detected by the terminal posture detection unit 602. As illustrated in FIG. 10A, an orthogonal coordinate system is defined to express the movement direction and the movement amount of the portable terminal 101. In other words, a normal-line direction of the touch panel display 201 of the portable terminal 101 is defined as a Z-axis, a short-side direction of the touch panel display 201 is defined as an X-axis, and a long-side direction of the touch panel display 201 is defined as a Y-axis. By thus defining, when the user holds the portable terminal 101 such that the long side of the portable terminal 101 matches with the perpendicular direction, the X-axis is a lateral direction, the Y-axis is a vertical direction, and the Z-axis is a front-back direction. As for the movement direction of the portable terminal 101, a leftward direction of the X-axis, a downward direction of the Y-axis, and a frontward direction of the Z-axis are each assumed to be a positive (+) movement direction. Further, a rightward direction of the X-axis, an upward direction of the Y-axis, and a backward direction of the Z-axis are each assumed to be a negative (−) movement direction.

FIG. 10B is a diagram illustrating an example of an acceleration value detected by the terminal posture detection unit 602 via the motion sensor 310, when the posture of the portable terminal 101 changes. Based on the detected acceleration [m/s2] of the portable terminal 101, a time integration value of the acceleration is acquired as a speed [m/s], and a time integration value of the speed is acquired as a movement amount [m]. In this way, the terminal posture detection unit 602 can acquire a rotation angle of the portable terminal 101 in an orthogonal coordinate system defined with reference to a gravity magnetic field. In addition, the terminal posture detection unit 602 can obtain an acceleration value corresponding to an orthogonal coordinate system defined with reference to the portable terminal 101. The terminal posture detection unit 602 can thereby detect the posture information (such as an upright/horizontal state, and a portrait/landscape state) of the portable terminal 101.

### <S403: Detailed Description of Imaging Object Recognition Processing>

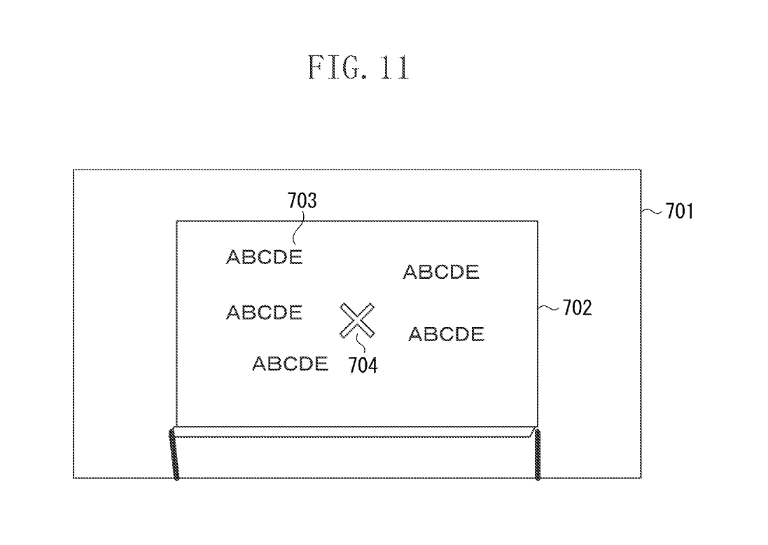

In step S403, the imaging object recognition unit 607 performs the recognition processing of an imaging object in the photographic image. Here, a case, in which printed paper, a whiteboard, and a blackboard each serve as the imaging object, is described as an example. FIG. 11 is a diagram illustrating an example of a photographic image obtained by imaging the whiteboard. FIG. 11 illustrates an imaging area 701 and a whiteboard area 702. Further, text 703 is written on the whiteboard.

As an example of processing of recognizing an imaging object as being a whiteboard, the imaging object recognition unit 607 performs acquisition of color distribution information. Specifically, the imaging object recognition unit 607 acquires the color distribution information of an image in a range set beforehand, from a center 704 of the imaging area 701. The color distribution information of the image is an example of characteristic amount information of an image. Further, the processing of acquiring the color distribution information from the photographic image is an example of extraction processing of extracting characteristic amount information from a photographic image. This processing can be performed by conventional processing of acquiring a histogram. In the whiteboard, a background plane is white, and the written text 703 is limited in terms of color as well. For example, the color of the text 703 can be limited to black, red, blue, and green. When white, black, red, blue, and green are stronger than other colors, the imaging object recognition unit 607 can recognize the imaging object being the whiteboard based on a histogram. As another applicable method, there is such a method that a whiteboard image has been registered beforehand, and the imaging object recognition unit 607 recognizes the imaging object as being the whiteboard by image recognition.

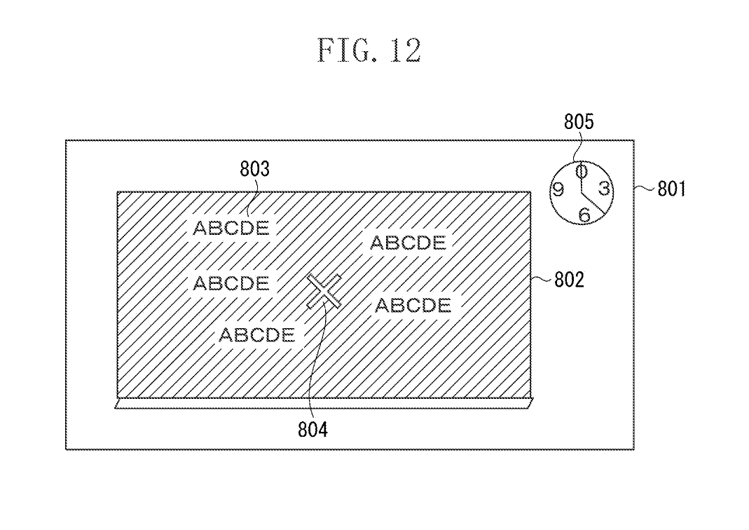

FIG. 12 is a diagram illustrating an example of the photographic image obtained by imaging a blackboard. FIG. 12 illustrates an imaging area 801 and a blackboard area 802. Further, a clock 805 appears in the imaging area 801 outside the blackboard area 802. In addition, text 803 is written on the blackboard.

As an example of processing of recognizing an imaging object as being a blackboard, the imaging object recognition unit 607 performs acquisition of color distribution information. Specifically, the imaging object recognition unit 607 acquires the color distribution information of an image in a range set beforehand, from a center 804 of the imaging area 801. This processing can be performed by conventional processing of acquiring a histogram. In the blackboard, a background plane is black or dark green, and the written text 803 is limited in terms of color as well. For example, the color of the text 803 can be limited to white, red, blue, and yellow. When black, white, red, blue, and yellow are stronger than other colors, the imaging object recognition unit 607 recognizes the imaging object as being the blackboard based on a histogram. As another applicable method, there is such a method that a blackboard image has been registered beforehand, and the imaging object recognition unit 607 recognizes the imaging object as being the blackboard by image recognition.

In the present exemplary embodiment, the imaging object recognized as neither the whiteboard nor the blackboard is assumed to be the paper. Further, the imaging object recognition unit 607 can narrow the imaging object by using the posture information of the portable terminal 101 acquired in step S402. This will be described below more in detail.

For example, assume that, in the posture information of the portable terminal 101 acquired in step S402, the value of the X-axis is 0, the value of the Y-axis is 0, and the value of the Z-axis is 10, as illustrated in FIG. 10B described above. In this case, the imaging object recognition unit 607 recognizes the imaging object as being the paper. Further, assume that, in the posture information of the portable terminal 101 acquired in step S402, the value of the X-axis is 0, the value of the Y-axis is 10, and the value of the Z-axis is 0, as illustrated in FIG. 10B described above. In this case, the imaging object recognition unit 607 recognizes the imaging object as being the whiteboard, the blackboard, or the paper put on a wall.

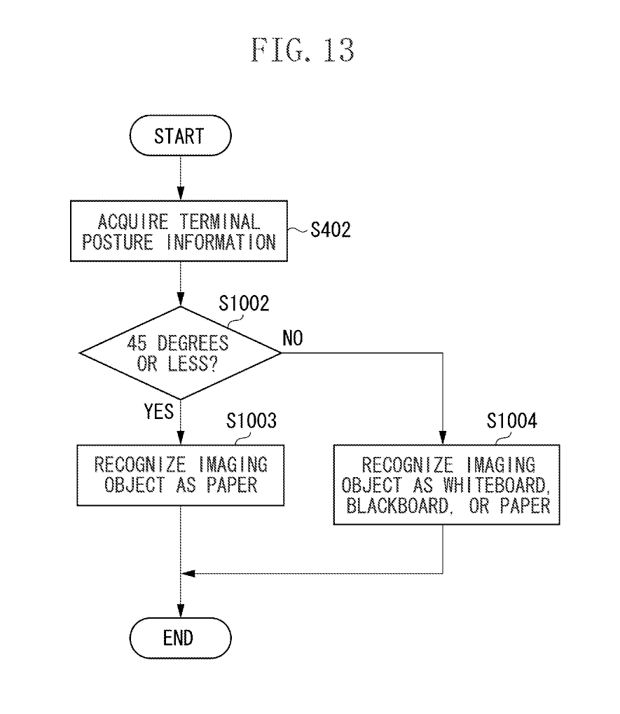

FIG. 13 is a flowchart illustrating an example of the imaging object recognition processing using the posture information of the portable terminal 101. Processing similar to the processing in FIG. 5 described above is provided with the same reference character as the reference character in FIG. 5, and will not be described. In step S1002, the imaging object recognition unit 607 determines whether an angle obtained from the posture information is equal to or less than a value set with respect to a plane (a plane orthogonal to the perpendicular direction). When the imaging object recognition unit 607 determines that the value is equal to or less than the set value (YES in step S1002), the processing proceeds to step S1003. When the imaging object recognition unit 607 determines that the value is not equal to or less than the set value (NO in step S1002), the processing proceeds to step S1004. Here, the set value is assumed to be 45 degrees. This angle is a value set from an angle conceivable for a case where an object on a desk or the like is imaged. In the case where the object on the desk or the like is imaged, as the angle of the portable terminal 101 becomes larger, the difference between the resolution at the back and the resolution at the front may become greater, or the visibility of text and the like at the back may be reduced. To avoid this situation, it is desirable to perform imaging in a state where the angle with respect to the plane of the portable terminal 101 is as close to 0 degree as possible.

If the angle with respect to the plane of the portable terminal 101 is 45 degrees or less (YES in step S1002), then in step S1003, the imaging object recognition unit 607 recognizes the imaging object as being the paper. On the other hand, when the angle with respect to the plane of the portable terminal 101 is not 45 degrees or less (NO in step S1002), then in step S1004, the imaging object recognition unit 607 recognizes the imaging object as being the whiteboard, the blackboard, or the paper put on the wall. The value of the angle serving as a threshold is freely settable, and is not limited to the value of 45 degrees. In addition, here, although the case where the imaging object is the whiteboard, the blackboard, or the paper put on the wall is described as an example, the imaging object may be other type of object. For example, the imaging object may be a presentation window projected onto a wall by using a liquid crystal projector.

In this way, the imaging object can be recognized in a simpler and faster manner, by thus performing the narrowing to the imaging object conceivable for the case where the angle is greater than the set value. Further, when two or more imaging objects are identified by the narrowing based on the angle of the portable terminal 101, the imaging object recognition unit 607 can identify one of the imaging objects based on the color distribution information acquired from the photographic image in the manner described above.

### <S404: Detailed Description of Document Area Recognition Processing>

In step S404, the document area recognition unit 603 performs processing of recognizing an outer frame (here, described as four sides) of a document area. The document area recognition unit 603 finds edges to delete or connect the found edges, thereby performing the detection of the sides. In this process, the document area recognition unit 603 changes the processing mode in the edge detection according to the type of the imaging object recognized in step S403. The four sides can be detected more accurately by changing edge intensity or luminance difference for performing the edge detection according to each of the imaging objects. In other words, for example, when the imaging object is recognized as the whiteboard, the document area recognition unit 603 performs the four sides detection for the whiteboard. In addition, when the imaging object is recognized as the blackboard, the document area recognition unit 603 performs the four sides detection for the blackboard. Similarly, when the imaging object is recognized as the paper, the document area recognition unit 603 performs the four sides detection for the paper. Setting information for the four sides detection according to each of the imaging objects is assumed to have been stored beforehand in the storage unit 304 or the like.

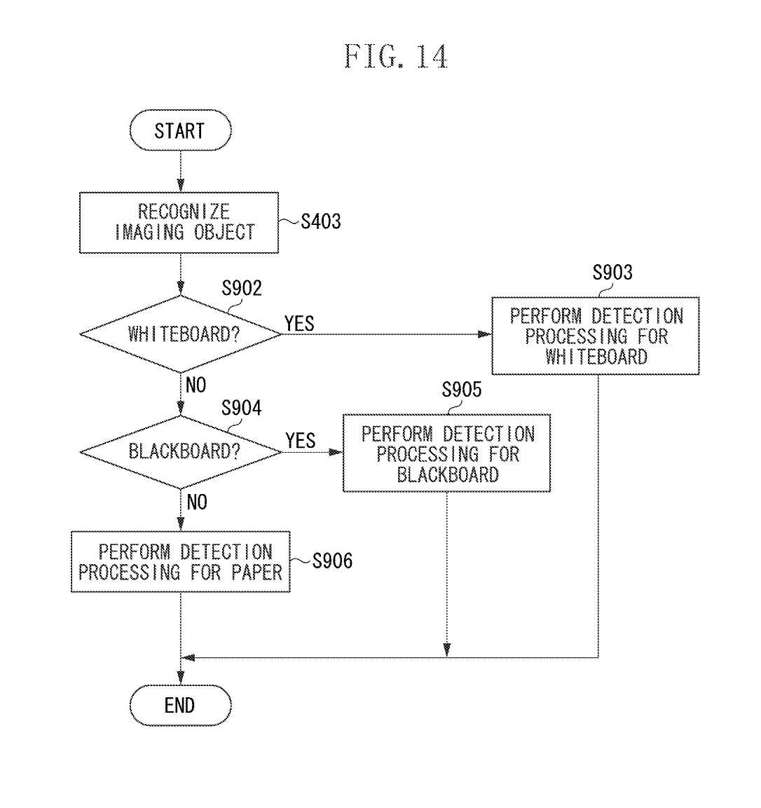

FIG. 14 is a flowchart illustrating an example of the document area recognition processing. Processing similar to the processing in FIG. 5 described above is provided with the same reference character as the reference character in FIG. 5, and will not be described. In step S902, the document area recognition unit 603 determines whether the imaging object recognized in step S403 is the whiteboard. When the document area recognition unit 603 determines that the imaging object is the whiteboard (YES in step S902), the processing proceeds to step S903. When the document area recognition unit 603 determines that the imaging object is not the whiteboard (NO in step S902), the processing proceeds to step S904. In step S903, the document area recognition unit 603 performs the above-described detection processing for the whiteboard.

In step S904, the document area recognition unit 603 determines whether the imaging object recognized in step S403 is the blackboard. When the document area recognition unit 603 determines that the imaging object is the blackboard (YES in step S904), the processing proceeds to step S905. When the document area recognition unit 603 determines that the imaging object is not the blackboard (NO in step S904), the processing proceeds to step S906. In step S905, the document area recognition unit 603 performs the above-described detection processing for the blackboard. In step S906, the document area recognition unit 603 performs the above-described detection processing for the paper.

When the document is imaged by the imaging processing unit 601, the document area recognition unit 603 extracts the apexes of the document area in the photographic image as illustrated in FIG. 6 described above. FIG. 6 illustrates the photographic image 1101 and the document area 1102, and the document area 1102 is a rectangular area surrounded by line segments linking the extracted apexes 1103, 1104, 1105, and 1106 of the document area. The apexes 1103 to 1106 of the rectangular document area can be extracted by, for example, a conventional method such as Douglas Peucker apex extraction algorithm.

As described above, according to the present exemplary embodiment, the photographic image can be processed more appropriately according to the posture of the portable terminal 101 when the imaging object is imaged. To be more specific, appropriate document area recognition and image processing that are suitable for the photographic image can be performed, by identifying the imaging object in the photographic image based on the posture information of the portable terminal 101. In addition, according to the present exemplary embodiment, each processing described above can be implemented without complicated instructions of the user.

In the above described first exemplary embodiment, there is described the example in which the imaging object recognition can be implemented in an easier and faster manner by recognizing the imaging object in the photographic image based on the posture information of the portable terminal 101. Now, in a second exemplary embodiment, there will be described an example in which the imaging object is recognized faster than the first exemplary embodiment by considering priority of imaging object recognition processing. In the second exemplary embodiment, a point different from the first exemplary embodiment will be mainly described.

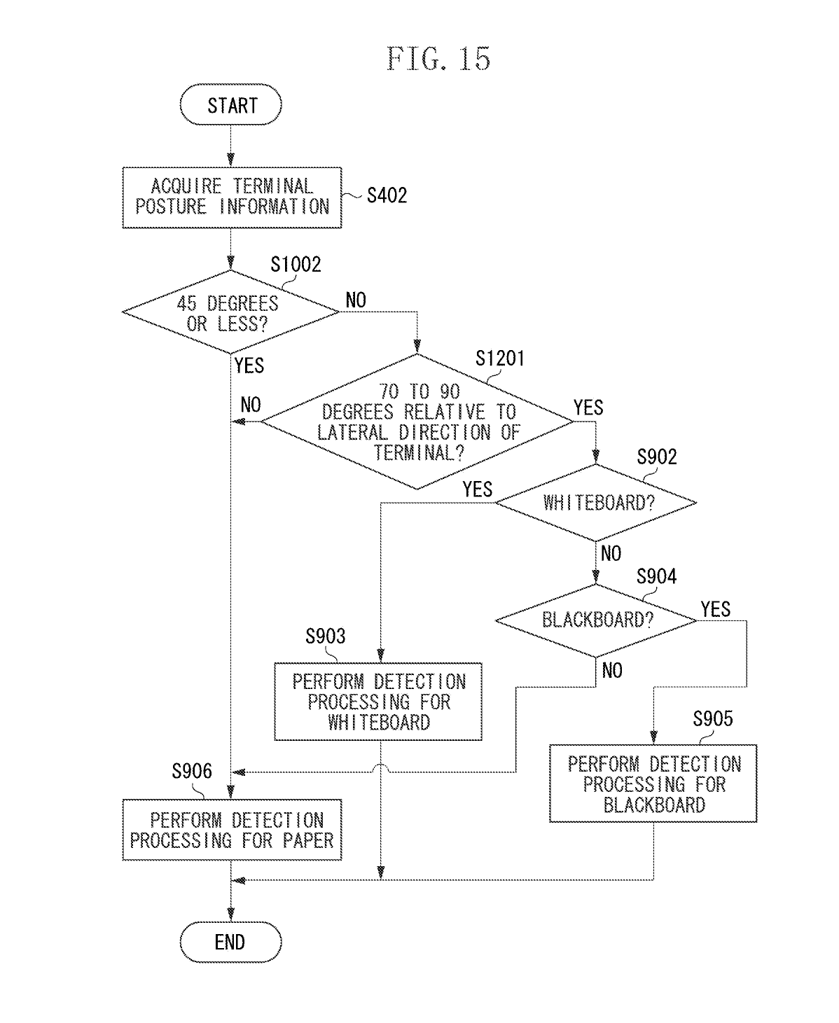

FIG. 15 is a flowchart illustrating an example of the imaging object recognition processing in the present exemplary embodiment. Processing similar to the processing in FIG. 13 described above is provided with the same reference character as the reference character in FIG. 13, and may not be described. When the imaging object recognition unit 607 determines, in step S1002, that an angle with respect to the orthogonal-to-screen direction (here, a direction parallel to a plane orthogonal to the perpendicular direction) of the portable terminal 101 obtained from the posture information is not 45 degrees or less (NO in step S1002), the processing proceeds to step S1201. On the other hand, when the imaging object recognition unit 607 determines that the angle is 45 degrees or less (YES in step S1002), the processing proceeds to step S906. In step S1201, the imaging object recognition unit 607 determines whether an angle with respect to the lateral direction of the portable terminal 101 is in a range from 70 degrees to 90 degrees. When the angle is determined to be in the range (YES in step S1201), the processing proceeds to step S902. In and after step S902, the processing of recognizing each of the whiteboard and the blackboard is performed by giving priority to this processing.

When the angle with respect to the lateral direction of the portable terminal 101 is in the range from 70 degrees to 90 degrees, the posture of the portable terminal 101 is a landscape state as illustrated in FIG. 8B described above. When imaging is performed with the portable terminal 101 in the landscape state, it is conceivable that an imaging object having an aspect ratio with a width value greater than a length value may be imaged. There are many whiteboards and blackboards each having an aspect ratio with a width value greater than a length value. Therefore, the imaging object recognition unit 607 narrows the imaging object to the whiteboard or the blackboard, when the imaging object is imaged in such a state that the angle with respect to the orthogonal-to-screen direction (here, the direction parallel to the plane orthogonal to the perpendicular direction) of the portable terminal 101 exceeds 45 degrees, and the posture is landscape. In this way, the priority for recognizing the imaging object is changed.

As for the orientation of the portable terminal 101, even if the posture illustrated in FIG. 8B is horizontally flipped, similar processing can be performed by recognizing the portable terminal 101 as being landscape as described above. In addition, the angle from 70 degrees to 90 degrees described is an example, and this angle is not limitative. This angle may be freely set, or a value therefor may be set beforehand in the ROM 303. In this process, for example, the CPU 301 may set a value in the ROM 303 according to a user operation received via the operation unit 308.

As described above, according to the present exemplary embodiment, in addition to the angle with respect to the orthogonal-to-screen direction of the portable terminal 101, the angle with respect to the lateral direction is considered, so that the priority of the imaging object recognition processing can be changed. Therefore, the recognition processing can be performed faster.

In the above described second exemplary embodiment, there is described the imaging object recognition processing, in which the imaging object is recognized by reflecting the priority in the recognition of the imaging object, using the two angles, i.e., the angle with respect to the orthogonal-to-screen direction of the portable terminal 101 and the angle with respect to the lateral direction. In a third exemplary embodiment, there will be described an example in which a setting window is provided to present an imaging-object recognition result to the user, and to receive a user instruction as to whether to change the recognition result, so that processing is performed according to the instruction. In the third exemplary embodiment, a point different from the first exemplary embodiment will be mainly described.

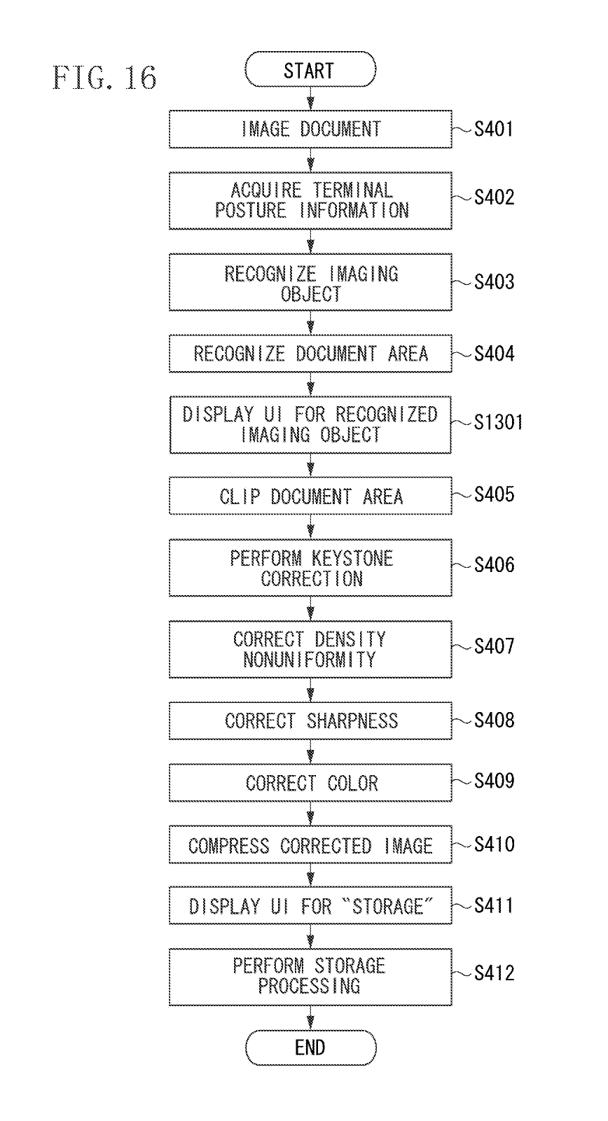

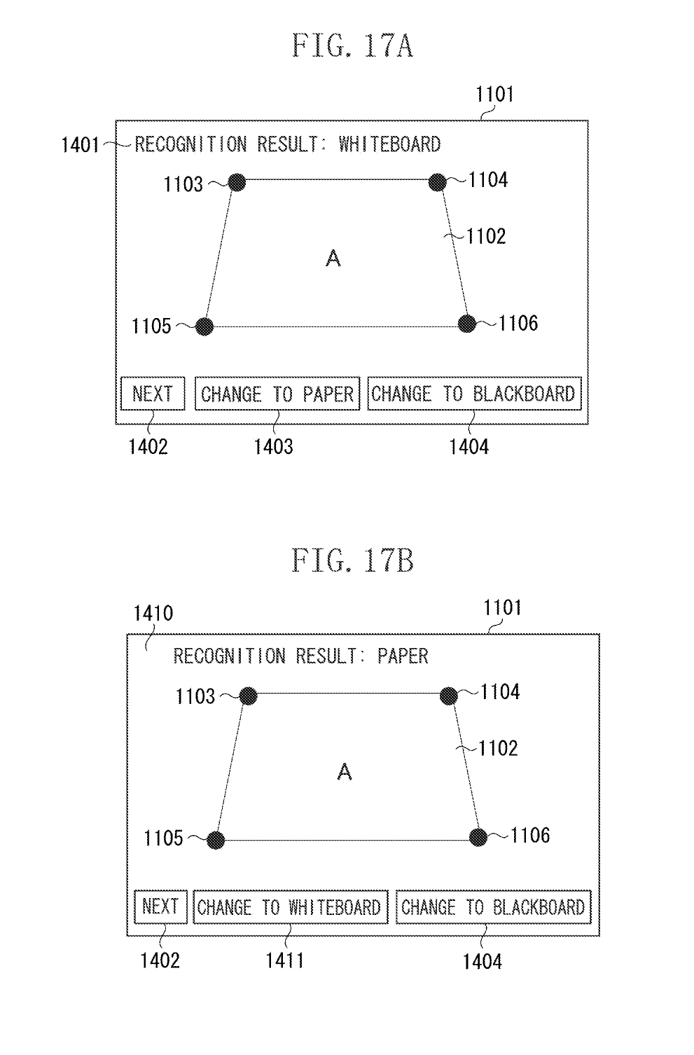

FIG. 16 is a flowchart illustrating an example of a series of processing steps in the third exemplary embodiment. Processing similar to the processing in FIG. 5 described above is provided with the same reference character as the reference character in FIG. 5, and will not be described. In step S1301, the UI display processing unit 606 causes display of a window for presenting the imaging object recognized in step S403 to the user. FIGS. 17A and 17B are diagrams each illustrating an example of the window (the setting window) displayed in the processing in step S1301. For the displayed window illustrated in each of FIGS. 17A and 17B, a point different from the displayed window illustrated in FIG. 6 will be mainly described. FIG. 17A illustrates a message 1401 indicating the imaging-object recognition result in the photographic image 1101. Further, FIG. 17A illustrates a window when the imaging object is recognized as the whiteboard in step S403 is displayed, as an example. The processing in step S1301 is an example of setting window display processing.

By viewing this displayed window, the user can not only confirm the result of detecting the document area, but also recognize the processing being performed for the whiteboard serving as the imaging object, and the image correction processing to be subsequently performed by using a parameter for the whiteboard. When the UI display processing unit 606 detects a press of a button 1402, processing in and after step S405 is performed. In the example in FIG. 17A, the processing suitable for the whiteboard is performed in and after S405. The suitable processing here is processing such as the image correction to be executed based on the parameter for the whiteboard. A button 1403 is provided to change the imaging object to the paper. A button 1404 is provided to change the imaging object to the blackboard. When the button 1403 is pressed, the document area recognition unit 603 performs the document area recognition processing in step S404 again for the imaging object of the paper. The UI display processing unit 606 then displays a window according to the result of this recognition processing.

FIG. 17B is a diagram illustrating an example of the displayed window when the document area recognition in step S404 is performed for the paper serving as the imaging object, in response to a press of the button 1403 in FIG. 17A. A message 1410 displays the imaging-object recognition result being the paper, to indicate the paper being processed as the imaging object, as instructed by the user. Since the imaging object is designated as the paper by the user, the UI display processing unit 606 may display information such as “document designation” in the message 1410, as the recognition result. A button 1411 is provided to change the imaging object to the whiteboard. The user can provide an instruction for returning the imaging object to the whiteboard by pressing the button 1411.

In the present exemplary embodiment, the UI display processing unit 606 displays the imaging-object recognition result in the window displaying the document-area recognition result obtained in step S404. However, the display timing and display form are not limited to this example. For example, the UI display processing unit 606 may display the recognition result at the time when the recognition of the imaging object is performed, or may display a window that can receive an instruction for changing the imaging object.

As described above, according to the above described third exemplary embodiment, a confirmation or an instruction by a user can be easily received for the processing to be performed based on the posture information of the portable terminal 101 and the imaging-object recognition result. Therefore, the processing suitable for the purpose of the user can be provided without any complicated UI operation.

In the first exemplary embodiment, as in the flowchart described with reference to FIG. 13, the imaging object recognition unit 607 recognizes the imaging object as the paper, when the angle indicated by the posture information of the portable terminal 101 does not exceed 45 degrees with respect to the plane. However, there is a case where the imaging object may not be the paper, even if the angle indicated by the posture information of the portable terminal 101 is smaller than the set value, and the portable terminal 101 is in a state of being almost horizontal to the desk. Examples include a case where the imaging object is an A4-size or A3-size whiteboard or blackboard placed on a desk. A fourth exemplary embodiment will be described using an example of displaying a window for prompting the user to confirm the imaging object to address such a case appropriately.

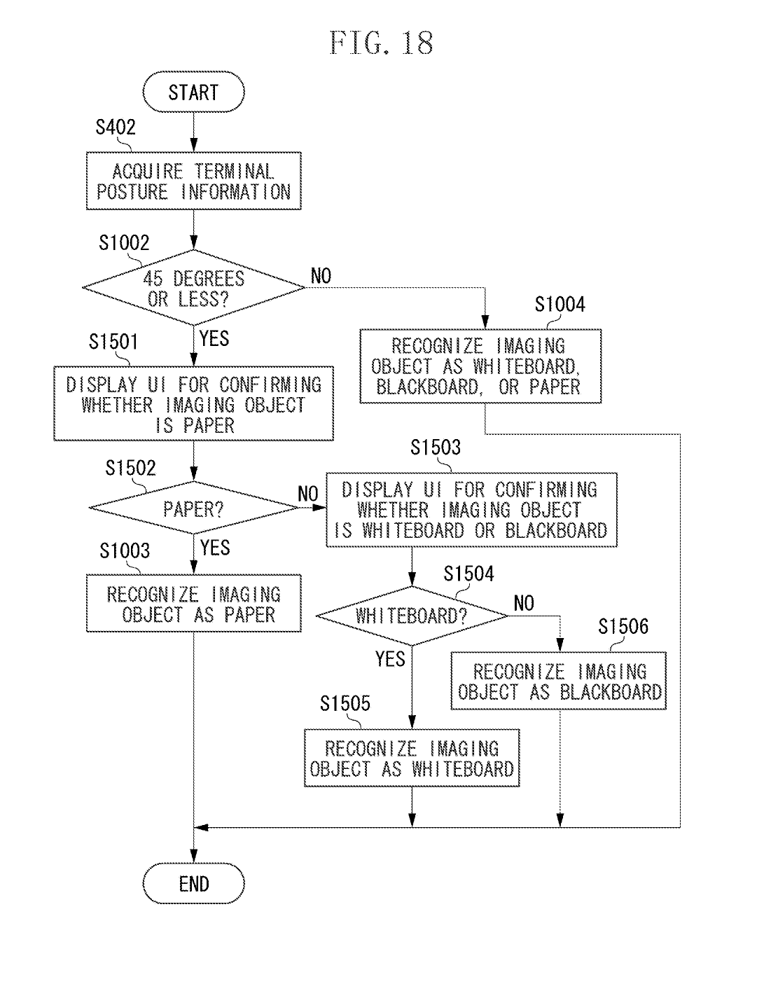

FIG. 18 is a flowchart illustrating an example of the imaging object recognition processing in the present exemplary embodiment. Processing similar to the processing in FIG. 13 described above is provided with the same reference character as the reference character in FIG. 13, and will not be described. In step S1501, the UI display processing unit 606 displays a window (a confirmation window) for allowing confirmation of whether the imaging object is the paper. In step S1502, the imaging object recognition unit 607 determines whether the paper being the imaging object is confirmed by a user operation via the window displayed in step S1501. When the paper being the imaging object is confirmed (YES in step S1502), processing the imaging object as the paper is performed in and after step S1003. On the other hand, when the paper not being the imaging object is confirmed (NO in step S1502), the processing proceeds to step S1503. In step S1503, the UI display processing unit 606 displays the whiteboard and the blackboard as options selectable as the imaging object.

In step S1504, the imaging object recognition unit 607 determines whether the whiteboard is selected as the imaging object by a user operation via the window displayed in step S1503. When the imaging object recognition unit 607 determines that the whiteboard is selected as the imaging object (YES in step S1504), processing in and after step S1505 is performed for the whiteboard being recognized as the imaging object. On the other hand, when the imaging object recognition unit 607 determines that the whiteboard is not selected as the imaging object (NO in step S1504), processing in and after step S1506 is performed for the blackboard being the imaging object.

In step S1505, the imaging object recognition unit 607 recognizes the imaging object as the whiteboard.

On the other hand, in step S1506, the imaging object recognition unit 607 recognizes the imaging object as the blackboard.

As described above, according to the present exemplary embodiment, the processing suitable for the imaging object taken by the user can be provided without requiring a complicated operation from the user, by performing display for allowing the user to conform the imaging object, by using the posture information of the portable terminal 101.

An exemplary embodiment of the present invention is also achievable by such processing that a program that implements one or more functions of the above-described exemplary embodiments is supplied to a system or apparatus via a network or storage medium. One or more processors in a computer of the system or apparatus read the program and then execute the read program. Moreover, an exemplary embodiment of the present invention is also achievable by a circuit (e.g., an application-specific integrated circuit (ASIC)) that implements one or more functions.

In addition, in the first to fourth exemplary embodiments described above, the portable terminal 101 is described as a terminal that processes the photographic image in the portable terminal 101, but the processing form is not limited to this example. For example, the portable terminal 101 may transmit a photographic image to the server 121, and the server 121 may perform image processing on the photographic image. In this case, the server 121 is an example of the information processing apparatus. The server 121 has at least a CPU and a memory as a hardware configuration. The CPU of the server 121 executes processing based on a program stored in the memory of the server 121, thereby implementing the processing in each of the exemplary embodiments described above.

As described above, according to each of the exemplary embodiments described above, there can be provided a technique, which is capable of processing a photographic image more appropriately, according to a posture of a portable terminal when an imaging object is imaged.

Exemplary embodiments have been described in detail. However, these specific exemplary embodiments are not seen to be limiting, and may be variously altered and/or modified within the scope and the essence of aspects of the present invention as claimed.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-017098, filed Jan. 30, 2015, which is hereby incorporated by reference herein in its entirety.

What is claimed is:

1. An information processing apparatus comprising:
an acquisition unit configured to acquire posture information of an imaging unit;
an extraction unit configured to extract characteristic amount information of an image imaged by the imaging unit;
an identification unit configured to identify a subject included in the image imaged by the imaging unit using the posture information acquired by the acquisition unit and the characteristic amount information extracted by the extraction unit;
a recognition unit configured to recognize a subject area in the image in a recognition mode according to the subject identified by the identification unit; and
a correction unit configured to correct the image including the subject area by clipping, from the image, the subject area recognized by the recognition unit.

2. The information processing apparatus according to claim 1, wherein the identification unit identifies the subject based on an angle of the imaging unit, the angle being indicated by the posture information.

3. The information processing apparatus according to claim 2, wherein when an angle with respect to a plane orthogonal to a perpendicular direction of the imaging unit is less than or equal to a predetermined value, the identification unit identifies the subject as a paper medium, and when the angle is greater than the predetermined value, the identification unit identifies the subject as a board medium.

4. The information processing apparatus according to claim 2, wherein when an angle with respect to a plane orthogonal to a perpendicular direction of the imaging unit is less than or equal to a predetermined value, the identification unit identifies the subject as a paper medium, and when the angle is greater than the predetermined value and an angle with respect to a lateral direction of the imaging unit is outside a predetermined range, the identification unit identifies the subject as the paper medium.

5. The information processing apparatus according to claim 1, wherein when a plurality of subjects is identified based on the posture information, the identification unit identifies one of the plurality of subjects based on the characteristic amount information extracted by the extraction unit.

6. The information processing apparatus according to claim 1, wherein the extraction unit acquires color distribution information in a predetermined range in the image as the characteristic amount information.

7. The information processing apparatus according to claim 1, wherein the recognition unit recognizes the subject area by changing a recognition mode of a boundary between the subject area and a background area in the image according to the subject identified by the identification unit.

8. The information processing apparatus according to claim 1, wherein the acquisition unit acquires angle information, calculated based on acceleration information acquired from a motion detection unit, indicating an angle of the imaging unit as the posture information.

9. The information processing apparatus according to claim 1, further comprising a setting window display unit configured to display a setting window for displaying the subject identified by the identification unit and for receiving an instruction for changing the identified subject.

10. The information processing apparatus according to claim 1, further comprising a confirmation window display unit configured to display a confirmation window for allowing a user to confirm whether the identified subject is correct, when the image is corrected by the correction unit.

11. The information processing apparatus according to claim 1, wherein the correction unit clips, from the image, the subject area recognized by the recognition unit and performs at least one of keystone correction for the subject area, density nonuniformity correction, color correction, or smoothing correction for the image.

12. The information processing apparatus according to claim 1, wherein the information processing apparatus is a portable terminal device.

13. An information processing method executed by an information processing apparatus, the information processing method comprising:
acquiring posture information of an imaging unit;
extracting characteristic amount information of an image imaged by the imaging unit;
identifying a subject included in the image imaged by the imaging unit using the acquired posture information and the extracted characteristic amount information;
recognizing a subject area in the image in a recognition mode according to the identified subject; and
correcting the image including the subject area by clipping, from the image, the recognized subject area.

14. A storage medium storing computer executable instructions that cause a computer to execute an information processing method, the information processing method comprising:
acquiring posture information of an imaging unit;
extracting characteristic amount information of an image imaged by the imaging unit;
identifying a subject included in the image imaged by the imaging unit using the acquired posture information and the extracted characteristic amount information;
recognizing a subject area in the image in a recognition mode according to the identified subject; and
correcting the image including the subject area, by clipping, from the image, the recognized subject area.
